(19) United States
(12) Patent Application Publication
(10) Pub. No.: US 2020/0368624 A1
(43) Pub. Date: Nov. 26, 2020

(54) METHOD SECURING DATA INTEGRITY OF ONLINE GOLF GAMES

(71) Applicants: YI-CHING PAO, SUNNYVALE, CA (US); JAMES PAO, SUNNYVALE, CA (US)

(72) Inventors: YI-CHING PAO, SUNNYVALE, CA (US); JAMES PAO, SUNNYVALE, CA (US)

(21) Appl. No.: 16/877,238

(22) Filed: May 18, 2020

Related U.S. Application Data
(60) Provisional application No. 62/850,436, filed on May 20, 2019.

(51) Int. Cl. A63F 13/655; A63F 13/792; G07F 17/32; A63F 13/335

(52) U.S. Cl. CPC A63F 13/655; A63F 13/792; A63F 2300/8011; A63F 13/335; G07F 17/3244

(57) ABSTRACT

An online gaming system verifying data integrity has a server hosting an online game. At least one gaming simulator is wirelessly coupled to the server. Data integrity circuitry is coupled to the server and the at least one gaming simulator. The data integrity circuitry ensures that sensory data inputs from the at least one gaming simulator are free from intentional manipulation.

### RELATED APPLICATIONS

This patent application is related to U.S. Provisional Application No. 62/850,436 filed May 20, 2019, entitled “Method Securing Data Integrity of Online Golf Games” in the names of Yi-Ching Pao and James Pao, and which is incorporated herein by reference in its entirety. The present patent application claims the benefit under 35 U.S.C § 119(e).

### TECHNICAL FIELD

The present application relates generally to the technical field of online gaming, and more specifically, to the technical field of a system and method to secure the integrity of input data from one or more connected live gaming platforms in order to maintain the integrity and fairness of a networked online game.

### BACKGROUND

Multiplayer network games have been around for many years. For example, many games, including both personal computer (PC) games and video console games, such as, but not limited to games run on game consoles such as Sony PlayStation®, PSP®, Nintendo Wii®, DS®, and Microsoft Xbox®, may support at least one network mode or online-mode. The network mode may allow multiple players to play in the same game environment at the same time over a given network. When playing in the online-mode, players can choose to play either in a competitive mode or a co-op mode, depending on the particular game being played. Typically, to initiate a game, each player may log onto a central server hosting the game on a network from their respective PCs or game consoles. For some games, the central game server may also provide a pairing service to allow players to find playing partners. A game session may start after all participating players have successfully joined and been authenticated by the server. Alternatively, some games may allow players to join an ongoing game session after the game has already started.

Having an online mode may be an advantage for many video games. Not only does it allow multiple gamers to play with or against each other in the same game session, it does so without requiring that they be in the same physical location or sharing the same display. With adequate network speed, gamers at different physical locations can battle each other in a game in real time as if they are sitting next to each other and playing the game from the same PC or game console. In fact, it is not uncommon to have players located in different parts of the world engaging each other in an online game session.

Online games may offer tournaments and wagering/rewarding competitions. In these types of setting, when the wager or reward reach certain values, the input data integrity becomes critically important to maintain the fairness and confidence of the online game players and needs to be free from any intentional manipulation.

Therefore, it would be desirable to provide a system and method that overcomes the above. The system and method would ensure the input data integrity and that the input data is free from any intentional manipulation.

### SUMMARY

In accordance with one embodiment, an online gaming system verifying data integrity device is disclosed. The online gaming system verifying data integrity has a server hosting an online game. At least one gaming simulator is wirelessly coupled to the server. Data integrity circuitry is coupled to the server and the at least one gaming simulator. The data integrity circuitry ensures that sensory data inputs from the at least one gaming simulator are free from intentional manipulation.

In accordance with one embodiment, an online golf gaming system verifying data integrity is disclosed. The online golf gaming system has a server hosting an online wagering golf game. At least one golf game simulator is wirelessly coupled to the server. Data integrity circuitry is coupled to the server and the at least one gaming simulator. The data integrity circuitry ensures that sensory data inputs from the at least one gaming simulator are from a user movement and free from user computer manipulated inputs.

In accordance with one embodiment, an online golf gaming system verifying data integrity is disclosed. The online golf gaming system has a server hosting an online wagering golf game. At least one golf game simulator is wirelessly coupled to the server. Data integrity circuitry is coupled to the server and the at least one gaming simulator. The data integrity circuitry ensures that sensory data inputs from the at least one gaming simulator are from a user movement and free from user computer manipulated inputs. The data integrity circuitry has a passive unit, an active unit and a decision making unit. The sensory data inputs are screened through the passive unit and the active unit for data integrity. The decision making unit determines if the sensory data input is sent to the server.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a block diagram of a prior art a system for connecting golf simulators together to form a game network for wager or reward competition;

FIG. 2 is a block diagram of an exemplary embodiment of a system for connecting golf simulators together to form a game network for wager or reward competition showing a data integrity unit in accordance with one aspect of the present application; and

FIG. 3 is a block diagram of an exemplary embodiment of the system of FIG. 2 showing a more detailed diagram of the data integrity unit in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

The present disclosure relates to a system and method to secure the integrity of input data from one or more connected live gaming simulator platforms in order to maintain the integrity and fairness of the networked online game. In a multiple gaming simulator platform online game, sensory data from various live gaming simulator platforms may be fed into a host unit through a network connection. Once the online games start to involve wagering and/or reward prices then the protection of the integrity of the sensory data become necessary to prevent any manipulation of the data which will make the game unfair and not trustworthy. The present disclosure describes both passive and active measures to ensure no manipulations and/or faking of the input sensory data will result in any unfair and predictable results of the online game.

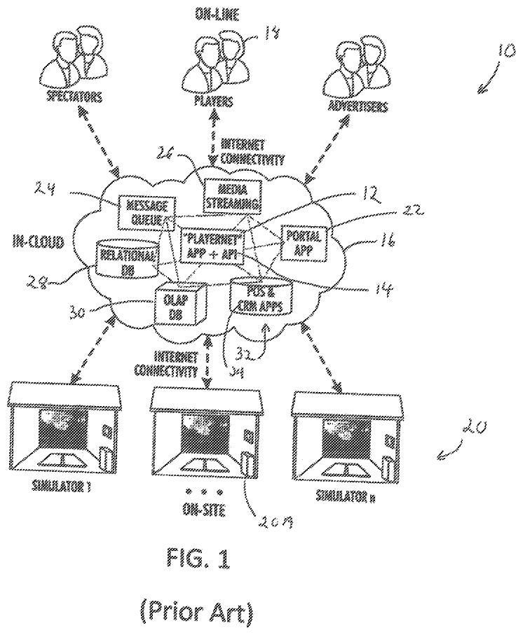

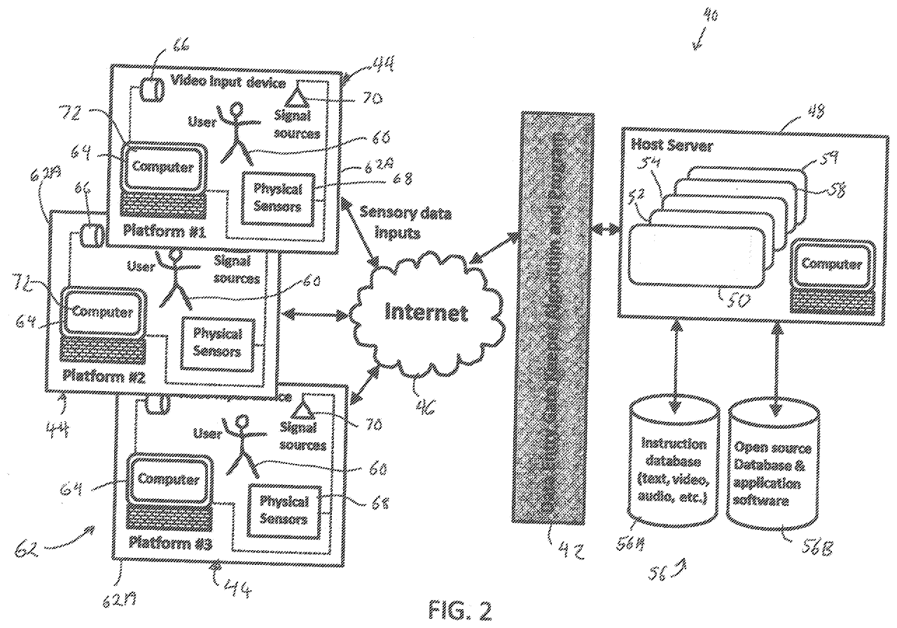

Referring to FIG. 1, a system 10 for connecting gaming simulators together to form a game network for wager or reward competition may be seen. The system 10 may have a gaming platform 12 which may be stored on a host server 32 (FIG. 2). The gaming platform 12 may be used to host an online game. In accordance with one embodiment, the gaming platform 12 may host an online golf game. The gaming platform 12 may have art associated application programming interface (API) 14. The API 14 may be used to connect the gaming platform 12 to a wireless network 16. The wireless network 16 may be a wireless network 16 such as, but not limited to a Local Area Network (LAN), a Wide Area Network (WAN) such as the internet or similar type of networks. When a player/user 18 (hereinafter user 18) accesses the gaming platform 12, the API 14 may connect to the wireless network 16 and send data to the gaming platform 12. The gaming platform 12 receives the data, interprets it, performs the necessary actions. Similarly, when the user 18 accesses the gaming platform 12 through a gaming simulator 20 via the wireless network 16, the API 14 interprets the data sent from the gaming simulator 20 and sends the data to the gaming platform 12 in a readable format.

The gaming platform 12 may be coupled to a portal application 22. The portal application 22 may be a platform accessible, interactive tool that delivers both related and unrelated applications, services and links for the gaming platform 12. For example, the portal application 22 may allow the gaming platform 12 to have a secure chat room, email or other messaging services 24, media streaming 26 as well as other services.

The gaming platform 12 may need to access one or more databases to store and analyze data. For example, the gaming platform 12 may store and use a relational database 28, an Online Analytical Processing (OLAP) database 30 and the like. The relational database 28 is a type of database that stores and provides access to data points that are related to one another. For example, the relational database 28 may have a first table. The first table may be customer information table storing a user's name, address, billing information, phone number, and other contact information. Each bit of information (each attribute) is in its own column, and the database assigns a unique ID (a key) to each row. A second table may be a user activity table. The user activity table may store user's gaming statistics and activity on the gaming platform, but not the user's name or contact information.

The OLAP database 30 is a database that may allow users to analyze database information from multiple database systems at one time. The OLAP database 30 may allow data mining, which aims to discover new relationships between different sets of data.

The gaming platform 12 may use a point of sale (POS) unit 32. The POS unit 32 may be used just for processing payments. From articulating sales data to processing mobile payments and managing customer relationships, the POS unit 32 may be used for a variety of purposes. The gaming platform 12 may also use a Customer Relationship Management (CRM) unit 34. The CRM unit 34 may be implemented into the POS unit 32. The CRM unit 34 may be used for managing the gaming platform's relationships and interactions with customers and potential customers.

In operation, the gaming platform 12 may acquire sensory data and/or gameplay data from an original live game simulator 20A through the network 16. Data from the live game simulator 20A may form the base of the online game. A remote user 18 may now participate in the game or tournament as if the game is present live. Once the live game simulator 20A is connected to the network 16, a network-connected online game or tournament may be able to connect many gaming simulators 20 in a plurality of sites or residences into an interactive player network. Other than simply play the online game for entertainment, a wagering game in accordance to a set of pre-determined game rules can also be applied.

The system 10 may implement a game network, wagering and rewarding activities. However, the issue of securing the sensory data inputs have not been addressed or raised. Partially this is because most of the users 18 of the system 10 are using the system 10 for casual entertainment. However, this will not be the case if a wager or reward reaches a certain high value. Since the online sensory data inputs, based on the actual user input, may be manipulated or faked, either by computer programs or systematic algorithm trending, the fairness and integrity of the online games may not be trustworthy. This is especially the case when different sensory platforms from various manufacturers are simultaneously used as the input devices. A traditional way to merge different sensory platform inputs is to standardize the data string format which will be generated at local platforms and sending the data to the host site for computation and trajectory calculations. Once the data string format is set, it is possible that anyone can use some manipulative algorithm to generate systematically faked input data in a fast repetition speed to gain unfair advantage over the online game when wager or reward are in stack. In order to ensure the integrity and honesty of the online games, it may be necessary to apply certain measures and methods to secure the integrity of the sensory data received from individual input platforms.

Referring to FIG. 2, a system 40 and method to secure the integrity of input data from one or more connected live gaming platforms in order to maintain the integrity and fairness of a networked online game may disclosed. The system 40 may use gate keeper/data integrity circuitry 42 (hereinafter data integrity circuitry 42). The data integrity circuitry 42 may be programmed to manage and control the traffic of the incoming sensory data which may be sent from individual player platforms 44 to the host through the wireless network 46. The data integrity circuitry 42 may screen any anomalies or questionable data strings through preset conditions. “Circuitry,” as used herein, includes, but is not limited to, hardware, firmware, a non-transitory computer readable medium that stores instructions, instructions in execution on a machine, and/or to cause (e.g., execute) an action(s). Circuitry can refer to, be part of, or include an Application Specific Integrated Circuit (ASIC), an electronic circuit, a processor (shared, dedicated, or group), logic device, and/or memory (shared, dedicated, or group) that execute one or more software or firmware programs, a combinational logic circuit, and/or other suitable hardware components that provide the described functionality. A logic device may be at least partially operable in hardware and can include one or more gates, combinations of gates, or other circuit components. In some embodiments, the circuitry can be implemented in, or functions associated with the circuitry can be implemented by, one or more software or firmware modules.

The data integrity circuitry 42 may implement the use of both “active” and “passive” measures within the online host program to ensure the integrity of the sensory data. In an online golf game, the common faking methods may be either through fast golf shot data generation of thousands of shots within a second by a computer with a given algorithm or systematically trending the shot parameters to “home in” on a given target. In order to defeat these shot data manipulating and faking attempts, two measures may be used as shown below:
1. Passive Measure:
   a. Human mode authentication,
   b. Platform must be registered,
   c. Control of any incoming data patterns or trends,
   d. Control of any incoming data timing and sequence.
2. Active Measure:
   a. Dynamic environmental conditions; changing wind speed and direction in a random format and timing,
   b. Dynamic ground conditions; changing ball restitution and ground slop in a random format and timing,
   c. Interactive and random golfer's club swing image taking during the game play.

Referring to FIG. 2, the system 40 may position the data integrity circuitry 42 between the wireless network 46 and the host server 48. The host server 48 may have a gaming platform 50 which may be stored on the host server 48 and/or accessible via a database coupled to the host server 48. The gaming platform 50 may be used to host an online game. In accordance with one embodiment, the gaming platform 50 may host an online golf game. The gaming platform 50 may have an associated application program interface (API) 52. The API 52 may be used to connect the gaming platform 50 to the wireless network 46. The wireless network 46 may be a wireless network 46 such as, but not limited to a Local Area Network (LAN), a Wide Area Network (WAN) such as the internet or similar type of networks. When a user 60 accesses the gaming platform 50, the API 52 may connect to the wireless network 42 and sends data to the gaming platform 50. The gaming platform 12 receives the data, interprets it, performs the necessary actions. Similarly, when the user 60 accesses the gaming platform 50 through a gaming simulator 62 via the wireless network 46, the API 52 may interpret the data sent from the gaming simulator 62 and send the data to the gaming platform 34 in a readable format.

As may be seen in FIG. 2, the gaming simulator 62 may have a computer 64, video input device 66, a plurality of sensors 68 and signal sources 70. In the present embodiment, the gaming simulator 62, may be a golf simulator 62A. In the golf simulator 62A, the user 60 may stand on a platform called a swing pad. The platform may be positioned in front of a screen 72. The screen 72 may displays images of a hole on a golf courses and/or other outside setting. The user 60 may swing a golf club and hit the ball on the screen 72 just like at a real driving range. The screen 72 may be connected to the computer 64 with sensors 68 used to measure the shot details and swing analysis. The sensors 68 may be an array of light sensors, radar and other motion detecting devices. The sensors 68 may be used to monitor the movement of the user 60 as well as the movement of a golf club and golf ball being used by the user.

The gaming platform 50 may be coupled to a portal application 54. The portal application 54 may be a platform accessible, interactive tool that delivers both related and unrelated applications, services and links. For example, the portal application 54 may allow the gaming platform 50 to have a secure chat room, email or other messaging services, media streaming as well as other services.

The gaming platform 34 may need to access one or more databases 56 to store and analyze data. For example, the gaming platform 34 may store and use an instructional database 56A, an open source database 56B and the like. The instructional database 56A may store video, text and/or other data on how to play the online game. The open source database 56B may be used to store software to run and analyze the online game.

The gaming platform 50 may use a point of sale (POS) unit 58. The POS unit 58 may be used just for processing payments. However, the POS unit 58 may be used for a variety of purposes. From articulating sales data to processing mobile payments and managing customer relationships, the POS unit 58 may be used for a variety of purposes. The gaming platform 50 may also use a Customer Relationship Management (CRM) unit 59. The CRM unit 59 may be implemented into the POS unit 58. The CRM unit 59 may be used for managing the gaming platform's relationships and interactions with customers and potential customers.

The host server 48 and/or computing devices 64 (hereinafter computing device 64) may be described in more detail in terms of the machine elements that provide functionality to the systems and methods disclosed herein. The components of the computing devices 64 may include, but are not limited to, one or more processors or processing units, a system memory, and a system bus that couples various system components including the system memory to the processor. The computing devices 64 may typically include a variety of computer system readable media. Such media could be chosen from any available media that is accessible by the computing devices 64, including non-transitory, volatile and non-volatile media, removable and non-removable media. The system memory could include one or more computer system readable media in the form of volatile memory, such as a random-access memory (RAM) and/or a cache memory. By way of example only, a storage system may be provided for reading from and writing to a non-removable, non-volatile magnetic media device typically called a “hard drive”.

The system memory may include at least one program product/utility having a set (e.g., at least one) of program modules that may be configured to carry out the functions of embodiments of the invention. The program modules may include, but is not limited to, an operating system, one or more application programs, other program modules, and program data. Each of the operating systems, one or more application programs, other program modules, and program data or some combination thereof, may include an implementation of a networking environment. The program modules generally carry out the functions and/or methodologies of embodiments of the invention as described herein.

The computing device 64 may communicate with one or more external devices such as a keyboard, a pointing device, a display 72, and/or any similar devices (e.g., network card, modem, etc.) that enable the computing device 64 to communicate with the host server 48. Such communication may occur via Input/Output (I/O) interfaces. Alternatively, the computing devices 64 may communicate with one or more networks such as a local area network (LAN), a general wide area network (WAN), and/or a public network (e.g., the network 46) via a network adapter. As depicted, the network adapter may communicate with the other components of the computing device 64 via the bus.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system) may be utilized. In the context of this disclosure, a computer readable storage medium may be any tangible or non-transitory mediums that can contain, or store a program (for example, the program product) for use by or in connection with an instruction execution system, apparatus, or device. A computer readable storage medium may be, for example, but not limited to, an electronic, magnetic, optical, electromagnetic, infrared or semiconductor system, apparatus, or device, or any suitable combination of the foregoing.

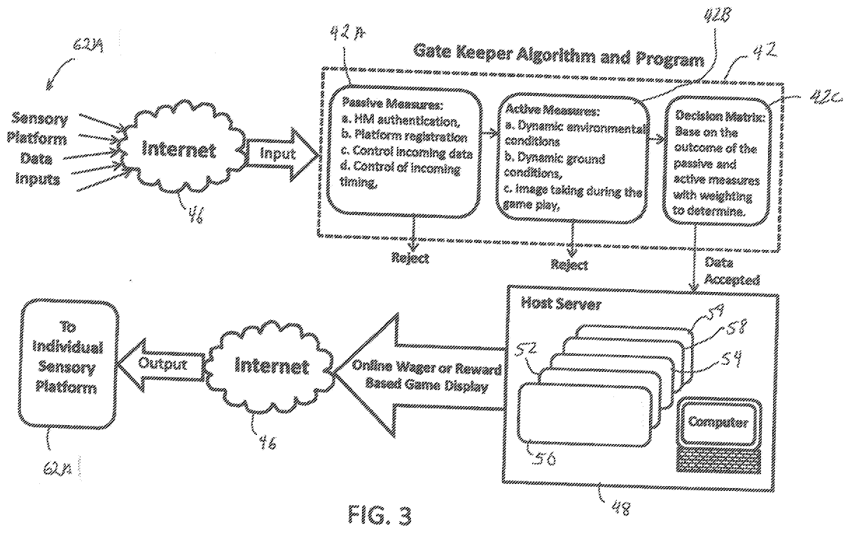

In accordance with one embodiment, the data integrity circuitry 42 may be applied only when the online games have competing wagers or rewards where the sensory based data may be used to determine the outcome. Referring to FIG. 3, a block diagram of the data integrity circuitry 42 may be seen. The data integrity circuitry 42 may have a passive unit 42A, an active unit 42B and a decision-making unit 42C.

The passive unit 42A may incorporate “passive” measures to ensure the integrity of the sensory data received from the gaming simulator 62. The “passive” measures may include a human authentication of the user 60. Human authentication may include verification of a human user 60. Verification may be accomplished via one or more of the sensors 68 and/or video input device 66. For example, the video input device 66 may be used to verify that a user 60 is present. Facial recognition may be used to verify that the user 60 is the person using the gaming simulator 62. Alternatively, or addition to, the user 60 may have to enter a response via the computer 64 to verify a human user 60.

The “passive” measures may include gaming platform registration. In accordance with one embodiment, the user 60 may need to register with the gaming platform 50 in order to play the online game. Registration may include, entering a user name, password and other identifying information. If the information entered is verified by the host server 48, the user 60 may participate in the online game. If the information entered is not verified by the host server 48, the user 60 may not be allowed to participate.

Another “passive” measure that may be used is control of the incoming data trends and entry patterns. Using this passive measure, the data integrity circuitry 42 may look for anomalies or questionable data strings that do not meet certain preset conditions. The data integrity circuitry 42 may look for anomalies in the user's behavior by statistically analyzing game events sent by the gaming simulator 62 to the host server 48.

Another “passive” measure that may be used is control of the incoming data timing and sequence. Using this passive measure, the data integrity circuitry 42 may look for an increase in speed of input data indicating that a computer may be being used to generate systematically faked input data. The data integrity circuitry 42 may look for lagging. Lagging may occur when the stream of data between one or more players gets slowed or interrupted, causing movement to stutter and making opponents appear to behave erratically. By using a lag switch, a user 60 may be able to disrupt uploads from the client to the server, while their own client queues up the actions performed. The data integrity circuitry 42 may look for latency issues which may indicate look-ahead cheating. Look-ahead cheating is a method of cheating within a peer-to-peer multiplayer gaming architecture where the cheating client gains an unfair advantage by delaying their actions to see what other players do before announcing its own action. A client can cheat using this method by acting as if it is suffering from high latency, the outgoing packet is forged by attaching a time-stamp that is prior to the actual moment the packet is sent, thereby fooling other clients into thinking that the action at the correct time, but was delayed in arrival.

The active unit 68 may incorporate “active” measures to ensure the integrity of the sensory data. The “active” measures may include dynamic and randomly changing golf playing environmental conditions and dynamic and randomly moving golf ball landing ground conditions. By changing the playing environmental conditions and ground conditions both of which may affect ball flight, and not having fixed conditions, it is harder for the user 60 to form a bot or other algorithm to manipulate the on-line sensory data inputs, based on the actual user input.

The “active” measures may include a last swing video image recording for actual swing play authentication. By recording the last swing image via the video image device 66, it may be compared to the data received to determine if the online sensory data input was manipulated. For example, if the last swing image recorded shows that the club face was closed at impact, but the data input shows a straight ball fight, the data integrity circuitry 42 may determine that the online sensory data inputs may have been manipulated.

In operation, the data integrity circuitry 42 may receive the online sensory data inputs from each gaming simulator 62. The online sensory data inputs may pass through the passive unit 42A. If the online sensory data inputs do not pass all of the passive measures in the pass unit 42A, online sensory data inputs may be rejected. In accordance with one embodiment, the operator of the gaming platform 50 may set the conditions for the passive measures and if one or more of the passive measures may need to be satisfied to continue.

If the online sensory data inputs satisfy the requirements of the passive unit 42A, the online sensory data inputs may be sent to the active unit 42B. If the online sensory data inputs do not pass all of the active measures in the active unit 42B, online sensory data inputs may be rejected. In accordance with one embodiment, the operator of the gaming platform 50 may set the conditions for the active measures and if one or more of the passive measures may need to be satisfied to continue.

The online sensory data inputs may be sent to a decision-making unit 42C. The decision making circuit 42C may determine if the conditions of the passive unit 42A and the active unit 42B have been meet. If the conditions have been met, the online sensory data inputs may be sent to through to the gaming platform 50. As stated above, the operator of the gaming platform 50 may set the conditions for the passive and active measures. The operator of the gaming platform 50 may place weighted values on the passive and active measures such that certain measure may be more important to verify than others.

The present disclosure is related to any online game with wager and/or reward are involved. In accordance with one embodiment, the online game is an online golf game. The online golf game may allow any individual sensory golf swing platforms to be used by any players who may log in and participate such online golf game. Data integrity circuitry gate may be placed in between the sensory golf swing platforms and the online game host server which secures and verifies that the data entry from these sensory golf swing platforms are both human player authenticated and not manipulated and/or faked. The data integrity circuitry may involve both passive and active measures to secure the entry data integrity from the sensory golf swing platform,

The foregoing description is illustrative of particular embodiments of the application, but is not meant to be a limitation upon the practice thereof. The following claims, including all equivalents thereof, are intended to define the scope of the application.

What is claimed is:

1. An online gaming system verifying data integrity comprising:
a server hosting an online game;
at least one gaming simulator wirelessly coupled to the server; and
data integrity circuitry coupled to the server and the at least one gaming simulator, the data integrity circuitry ensuring that sensory data inputs from the at least one gaming simulator are free from intentional manipulation.

2. The online gaming system of claim 1, wherein the data integrity circuitry uses both passive and active measures to ensuring that sensory data inputs from the at least one gaming simulator are free from intentional manipulation.

3. The online gaming system of claim 1, wherein the data integrity circuit comprises:
a passive unit;
an active unit; and
a decision making unit.

4. The online gaming system of claim 3, wherein the passive unit performs at least one of: user mode authentication, gaming simulator registration, monitoring abnormal incoming data patterns or trends, or monitoring abnormal incoming data timing and sequence.

5. The online gaming system of claim 3, wherein the passive unit performs user mode authentication, gaming simulator registration, monitoring abnormal incoming data patterns or trends, and monitoring abnormal incoming data timing and sequence.

6. The online gaming system of claim 3, wherein the active unit performs one of: dynamic environmental conditions of the online game, changing weather conditions of the online game, changing ground conditions of the online game, and taking user image playing the online game.

7. The online gaming system of claim 3, wherein the active unit performs dynamic environmental conditions of the online game, changing weather conditions of the online game, changing ground conditions of the online game, and taking user image playing the online game.

8. The online gaming system of claim 3, wherein the sensory data inputs are screened through the passive unit and the active unit for data integrity, the decision making unit determining if the sensory data input is sent to the server.

9. The online gaming system of claim 1, wherein the at least one gaming simulator comprises:
a computer;
a video input device; and
a plurality of sensors monitoring movement.

10. An online golf gaming system verifying data integrity comprising:
a server hosting an online wagering golf game;
at least one golf game simulator wirelessly coupled to the server; and
data integrity circuitry coupled to the server and the at least one gaming simulator, the data integrity circuitry ensuring that sensory data inputs from the at least one gaming simulator are from a user movement and free from user computer manipulated inputs.

11. The online golf gaming system of claim 10, wherein the data integrity circuitry uses both passive and active measures to ensuring that sensory data inputs from the at least one golf game simulator are from the user movement and free from user computer manipulated inputs.

12. The online golf gaming system of claim 10, wherein the data integrity circuitry comprises:
a passive unit;
an active unit; and
a decision making unit.

13. The online golf gaming system of claim 12, wherein the passive unit performs at least one of: user mode authentication, gaming simulator registration, monitoring abnormal incoming data patterns or trends, or monitoring abnormal incoming data timing and sequence.

14. The online golf gaming system of claim 12, wherein the passive unit performs user mode authentication, gaming simulator registration, monitoring abnormal incoming data patterns or trends, and monitoring abnormal incoming data timing and sequence.

15. The online golf gaming system of claim 12, wherein the active unit performs one of: dynamic environmental conditions of the online game, changing weather conditions of the online game, changing ground conditions of the online game, and taking user image playing the online game.

16. The online golf gaming system of claim 12, wherein the active unit performs dynamic environmental conditions of the online game, changing weather conditions of the online game, changing ground conditions of the online game, and taking user image playing the online game.

17. The online golf gaming system of claim 12, wherein the sensory data inputs are screened through the passive unit and the active unit for data integrity, the decision making unit determining if the sensory data input is sent to the server.

18. An online golf gaming system verifying data integrity comprising:
a server hosting an online wagering golf game;
at least one golf game simulator wirelessly coupled to the server; and
data integrity circuitry coupled to the server and the at least one gaming simulator, the data integrity circuitry ensuring that sensory data inputs from the at least one gaming simulator are from a user movement and free from user computer manipulated inputs, wherein the data integrity circuitry comprises:
a passive unit;
an active unit; and
a decision making unit;
wherein the sensory data inputs are screened through the passive unit and the active unit for data integrity, the decision making unit determining if the sensory data input is sent to the server.

19. The online golf gaming system of claim 18, wherein the passive unit performs user mode authentication, gaming simulator registration, monitoring abnormal incoming data patterns or trends, and monitoring abnormal incoming data timing and sequence.

20. The online golf gaming system of claim 18, wherein the active unit performs dynamic environmental conditions of the online game, changing weather conditions of the online game, changing ground conditions of the online game, and taking user image playing the online game.
